(19) United States
(12) Patent Application Publication
(10) Pub. No.: US 2024/0354583 A1
(43) Pub. Date: Oct. 24, 2024

(54) ROAD ANALYSIS WITH UNIVERSAL LEARNING

(71) Applicant: NEC Laboratories America, Inc., Princeton, NJ (US)

(72) Inventors: Sparsh Garg, Fremont, CA (US); Samuel Schulter, Long Island City, NY (US); Bingbing Zhuang, Santa Clara, CA (US); Manmohan Chandraker, Santa Clara, CA (US)

(21) Appl. No.: 18/615,535

(22) Filed: Mar. 25, 2024

Related U.S. Application Data
(60) Provisional application No. 63/460,656, filed on Apr. 20, 2023.

(51) Int. Cl. G06N 3/0895

(52) U.S. Cl. CPC G06N 3/0895

(57) ABSTRACT

Methods and systems for training a model include annotating a subset of an unlabeled training dataset, that includes images of road scenes, with labels. A road defect detection model is iteratively trained, including adding pseudo-labels to a remainder of examples from the unlabeled training dataset and training the road defect detection model based on the labels and the pseudo-labels.

### RELATED APPLICATION INFORMATION

This application claims priority to U.S. Patent Application No. 63/460,656, filed on Apr. 20, 2023, incorporated herein by reference in its entirety.

### BACKGROUND

### Technical Field

The present invention relates to road analysis and, more particularly, to machine learning systems that monitor infrastructure.

### Description of the Related Art

Infrastructure maintenance is a process that has a proactive part and a reactive part. Whereas the proactive part includes regularly scheduled maintenance to prevent problems from occurring, the reactive part includes repairs to defects and other infrastructural problems that have already occurred. Reactive maintenance is based on reporting or discovery of such defects, and cannot occur until information about the defect has been collected.

### SUMMARY

A method for training a model includes annotating a subset of an unlabeled training dataset, that includes images of road scenes, with labels. A road defect detection model is iteratively trained, including adding pseudo-labels to a remainder of examples from the unlabeled training dataset and training the road defect detection model based on the labels and the pseudo-labels.

A system for training a model includes a hardware processor and a memory that stores a computer program. When executed by the hardware processor, the computer program causes the hardware processor to annotate a subset of an unlabeled training dataset, that includes images of road scenes, with labels, and to iteratively train a road defect detection model, including adding pseudo-labels to a remainder of examples from the unlabeled training dataset and training the road defect detection model based on the labels and the pseudo-labels.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a vehicle in a road scene, where the road in the road scene includes defects, in accordance with an embodiment of the present invention;

FIG. 2 is a block/flow diagram of a method for training a model, in accordance with an embodiment of the present invention;

FIG. 3 is a block/flow diagram of a method for training and using a model to remediate and avoid faults in a road, in accordance with an embodiment of the present invention;

FIG. 4 is a diagram of an autonomous vehicle that can automatically detect and avoid faults in a road, in accordance with an embodiment of the present invention;

FIG. 5 is a block diagram of a computing device that can train and use a fault detection model, in accordance with an embodiment of the present invention;

FIG. 6 is a diagram of a neural network architecture that can be used in a fault detection model, in accordance with an embodiment of the present invention; and

FIG. 7 is a diagram of a deep neural network architecture that can be used in a fault detection model, in accordance with an embodiment of the present invention.

### DETAILED DESCRIPTION OF PREFERRED EMBODIMENTS

Infrastructure monitoring can be made automatic, for example using cameras on self-driving vehicles and other sources to gather information about the infrastructure's condition to detect defects, faults, and other features that may need maintenance or repair. Such automatic monitoring of infrastructure may identify areas of attention that need maintenance, may monitor in case of bad weather and other environmental hazards, and may detect road attributes for other purposes. Such attributes may be localized on a map, which can be used to guide maintenance crews and which can also be used to inform self-driving vehicles of potential hazards, so they can route away from danger.

To that end, a machine learning model can be used to identify specific infrastructural problems. While road conditions are specifically contemplated herein, it should be understood that the same principles can be applied to other types of infrastructure. For example, specific problems with a road surface may be identified using a universal learning approach, creating pseudo-labels to train a model. The model identifies maintenance areas of the road with relatively few annotated training samples.

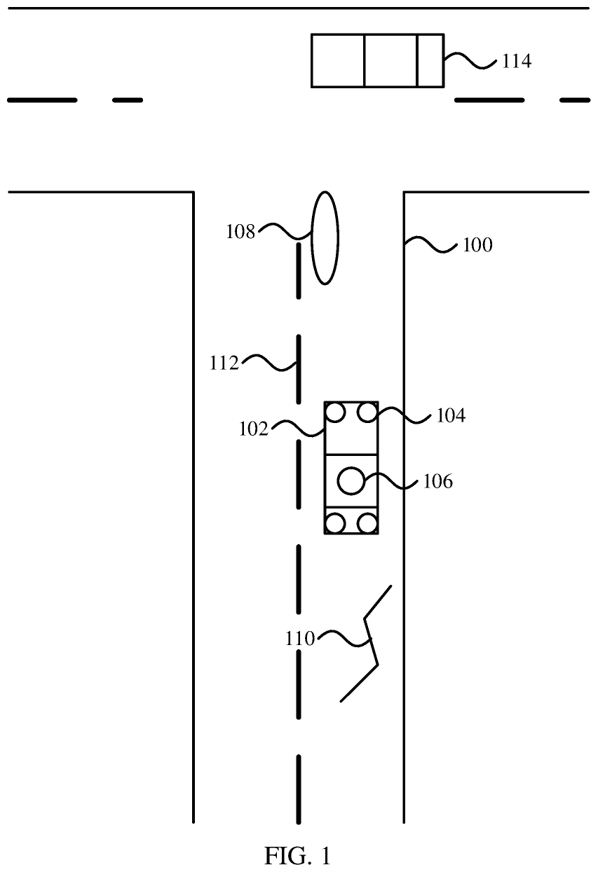

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree LiDAR sensor 106, positioned to gather geometric information about the road 100 all around the vehicle 102.

The vehicle 102 records information from its sensors. The information may be used to identify flaws in the road 100, which can be used to inform safe operation of the vehicle and to schedule maintenance for infrastructural problems. The sensors may also collect information relating to other objects in the environment, such as other vehicles 114, structural features such as lamp posts, as well as animals and pedestrians.

Exemplary infrastructure defects and faults include potholes 108, ruts, cracks 110, and fading in road markings 112. Other types of defect and faults may include obstructions or foliage that falls or reaches onto the roadway. These flaws may appear on one or both modalities. For example, LiDAR information is sensitive to geometric information and will indicate the shape of the road's surface. This is particularly useful for detecting potholes 108 and cracks 110, but LiDAR sensors 106 may have difficulty identifying defects in the road markings 112. The visual sensors 104, meanwhile, would be well adapted to defects in road markings 112, but may miss potholes 108 and cracks 110 in adverse lighting conditions. Additionally, when used in combination, the different modalities reinforce one another and provide superior results even in cases where each would independently be able to recognize the road flaw.

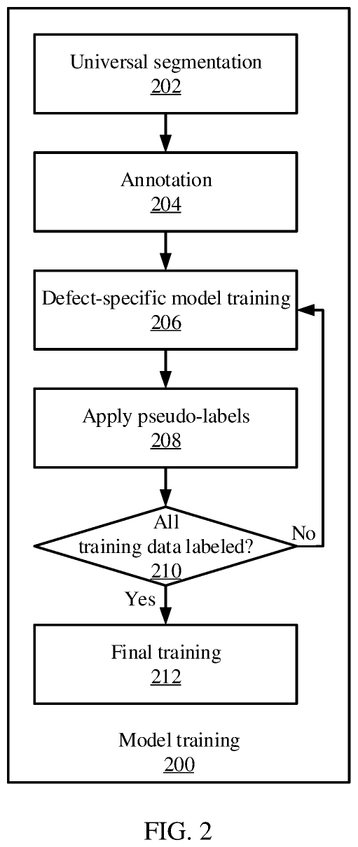

Referring now to FIG. 2, a model training method 200 is shown. Block 202 performs universal segmentation on a set of samples from an unlabeled training dataset. For example, universal segmentation may generate semantic maps of different categories, such as road scene attributes, which act as an input for training particular defect-specific models. Block 204 annotates the segmented images, for example labeling a first sub-set that shows ruts and cracks and a second subset that shows faded lines or other road markings. These annotations act as the ground truth for training the defect-specific models.

Individual models may be trained 206 to detect specific types of defect. Following the example of roadway defects, there may be a detector trained to detect ruts, potholes, and cracks, a detector trained to detect faded road markings, and a detector trained to detect foliage. A ruts/cracks detector may use, for example, a residual neural network backbone may be used to train a semantic image segmentation task that predicts probabilities of image features, such as “sky,” “building,” “road,” “car,” “lane,” “rut,” and “crack.” A faded marking detector may divide the input into multiple chunks of a predetermined size (e.g., 128×128 pixels) and may identify the chunks which have pixels that represent lane markings. The faded marking detector may include a binary classifier based on a residual neural network to predict whether a given chunk has faded lane markings. A foliage detector may use a depth model to identify the depth of an input image and may convert the resulting depth map to a point cloud. Points corresponding to trees and roads may be filtered, and a percentage may be determined for the points representing parts of trees that overlap with parts of the road.

The outputs of these different detectors may be combined to generate an overlay for the input image, indicating the predicted positions of ruts, cracks, faded markings, and foliage. A top-down view of the area can be shown to further indicate foliage locations. Defects can further be logged on a map using coordinates measured by global positioning satellite (GPS).

The ruts/cracks detector and the faded marking detector may be trained using a weakly supervised approach that combines supervised training and unsupervised training. For example, only part of a training dataset may be annotated (e.g., 10%) for an initial supervised training, and the remainder may be used for unsupervised training. The annotations may include a subset that are annotated for ruts and cracks and a subset that are annotated for faded markings.

The unsupervised training may be performed by using the model to generate and apply pseudo-labels in block 208 for the remainder of the training dataset (e.g., the other 90%), with a confidence value. Those training samples that have a pseudo-label with a confidence value above a confidence threshold (e.g., greater than 50%) may be used for further training 206 in subsequent epochs. This process may be performed iteratively, with block 210 determining whether all of the training data has been labeled before returning to block 206 for the next iteration. More and more images will reach the confidence threshold at each iteration, until the entire training dataset has been labeled with sufficiently high-confidence pseudo-labels. At that point, the final training of the detector may be performed at block 212, using the full set of labeled images.

In some cases, one or more images may never reach the threshold level of confidence. This iterative process may therefore be performed until the confidence level converges to some stable sub-threshold value or until a predetermined number of iterations have been performed. Any images with labels that remain below the confidence threshold may be omitted from the final training of the detector.

The foliage detector may generate a depth map from an input image to show the distance of objects from the camera location. The depth map may be generated by, for example, a monocular depth estimation model. A semantic map may also be generated for the image using a universal segmentation model to provide the pixel-wise classification of objects in the input image. The points of the depth map may be filtered according to their semantic meaning, for example identifying points that belong to the road and to trees. For example, if a given pixel at position (x,y) in the image belongs to the road or to a tree, its corresponding depth point may be stored and then converted to a point cloud. The point clouds may then be converted to a birds-eye view matrix to determine whether tree points overlap with road points. Any such overlap indicates a potential foliage obstruction, for example if a tree branch is damaged and falls onto the road.

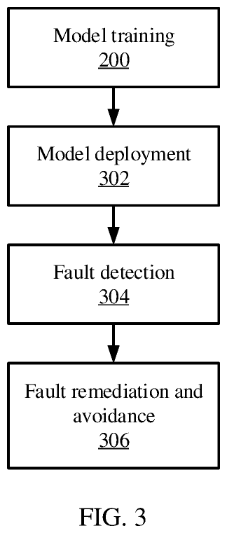

Referring now to FIG. 3, a method of training and using a road fault detection system is shown. As described above, the model may be trained using a partially annotated dataset, for example using a weakly supervised approach that generates its own pseudo-labels for unlabeled data based on a small subset of labeled training examples. Having trained the model, it may be deployed 302 for use in identifying actual or potential road faults.

The model may then be used for fault detection 304. For example, new images may be collected from video cameras 104 on a vehicle 102 to identify damage to the road. In the case of a self-driving vehicle, block 306 may issue instructions to the vehicle to cause it to avoid the road fault, for example by changing direction to steer clear of a pothole or other hazard. In some cases, block 306 may further trigger correction of the fault itself, for example by issuing a notification to a road maintenance agency. The notice may alert that agency to the need to fix damage to the road, to re-paint faded markings, and/or to remove foliage that impinges onto the roadway. The notice may include GPS coordinates indicating the location of the fault or potential fault.

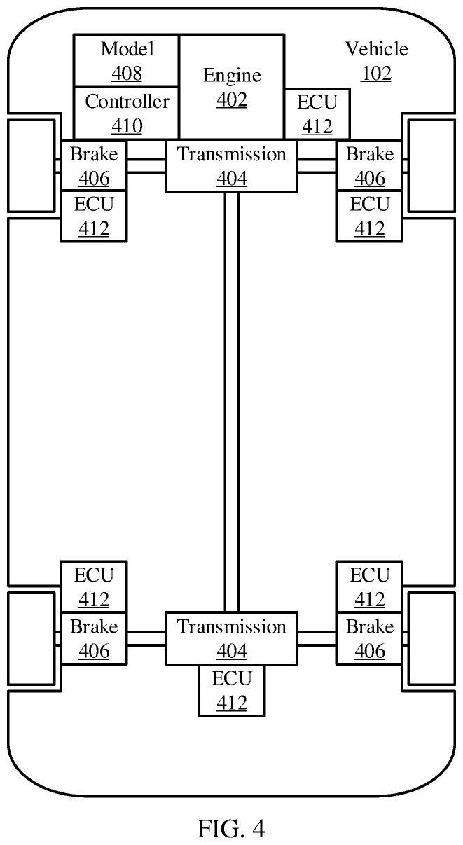

Referring now to FIG. 4, additional detail on a vehicle 102 is shown. A number of different sub-systems of the vehicle 102 are shown, including an engine 402, a transmission 404, and brakes 406. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 412, which perform measurements of the state of the respective sub-system. For example, ECUs 412 relating to the brakes 406 may control an amount of pressure that is applied by the brakes 406. An ECU 412 associated with the wheels may further control the direction of the wheels. The information that is gathered by the ECUs 406 is supplied to the controller 410.

Communications between ECUs 412 and the sub-systems of the vehicle 102 may be conveyed by any appropriate wired or wireless communications medium and protocol. For example, a car area network (CAN) may be used for communication. The time series information may be communicated from the ECUs 406 to the controller 410, and instructions from the controller 410 may be communicated to the respective sub-systems of the vehicle 102.

The controller 410 uses the fault detection model 408, based on information collected from cameras 104, to identify faults in the road. The model 408 may, for example, output a labeled image of a road scene that is labeled according to faults that have been detected.

The controller 410 may communicate internally, to the sub-systems of the vehicle 102 and the ECUs 406, as well as externally, to a fault remediation agency. For example, the controller 410 may receive model updates from a model training system during deployment 302, and may furthermore provide information relating to detected faults to the fault remediation agency.

Based on detected road fault information, the controller 410 may communicate instructions to the ECUs 412 to avoid a hazardous road condition. For example, the controller 410 may automatically trigger the brakes 406 to slow down the vehicle 102 and may furthermore provide steering information to the wheels to cause the vehicle 102 to move around a hazard.

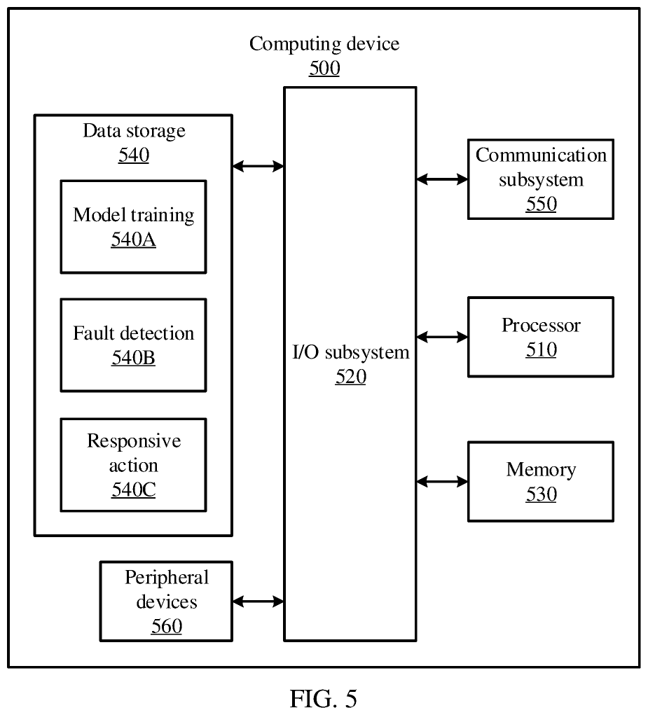

Referring now to FIG. 5, an exemplary computing device 500 is shown, in accordance with an embodiment of the present invention. The computing device 500 is configured to perform review summarization.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for training a model, 540B for performing road fault detection, and/or 540C for performing an automatic action a detected road fault. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

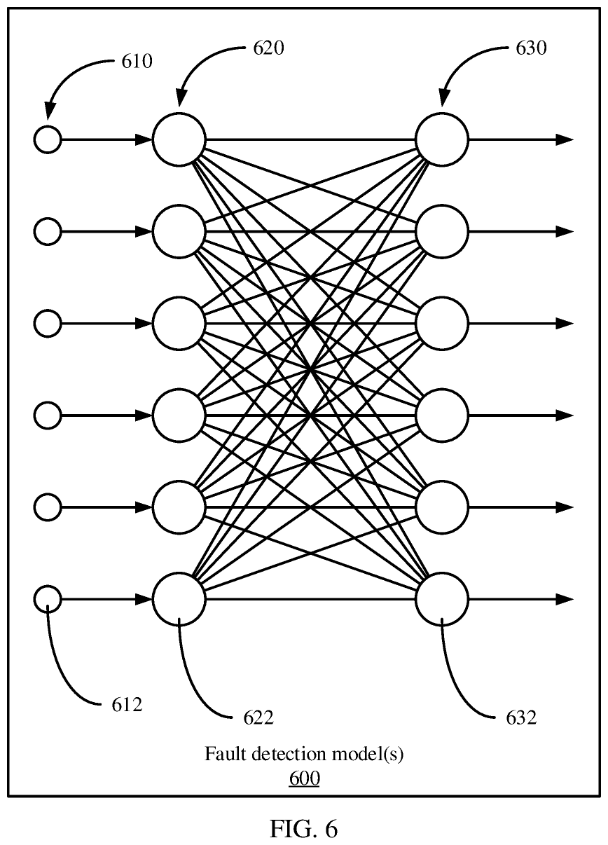

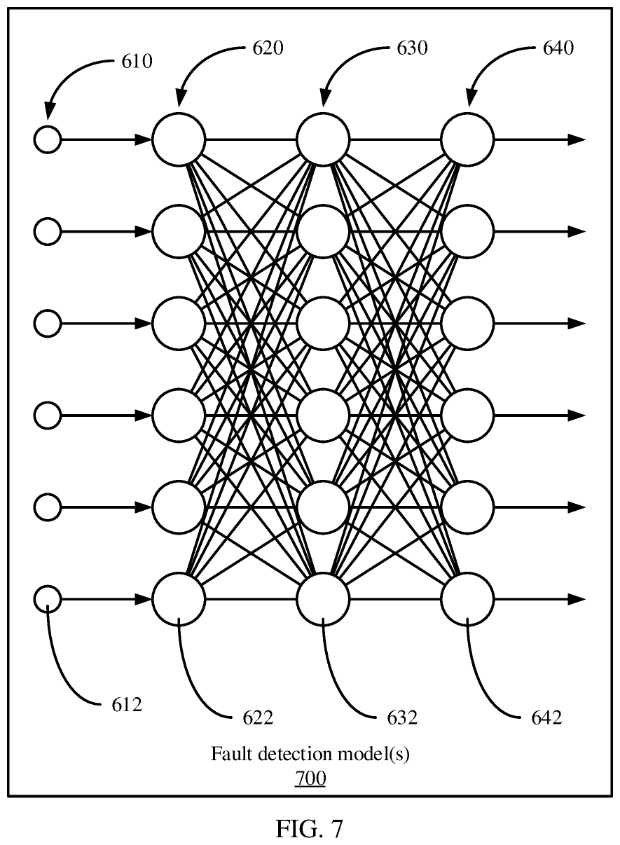

Referring now to FIGS. 6 and 7, exemplary neural network architectures are shown, which may be used to implement parts of the present models, such as the fault detection model(s) 600/700. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
annotating a subset of an unlabeled training dataset, that includes images of road scenes, with labels; and
iteratively training a road defect detection model, including adding pseudo-labels to a remainder of examples from the unlabeled training dataset and training the road defect detection model based on the labels and the pseudo-labels.

2. The method of claim 1, wherein the training dataset includes images that depict multiple categories of road defect, including cracks, ruts, and faded road markings.

3. The method of claim 1, wherein the training dataset further includes images that depict foliage.

4. The method of claim 3, further comprising training a foliage detection model that identifies locations where foliage poses a potential future road hazard.

5. The method of claim 4, wherein the foliage detection model identifies pixels that correspond to foliage and pixels that correspond to a road in an input image and determines locations where the foliage extends over the road.

6. The method of claim 5, wherein the foliage detection model combines semantic segmentation of the input image with a depth map based on the input image to identify overlapping foliage points and road points.

7. The method of claim 1, wherein iteratively training the road defect detection model includes adding the pseudo-labels to examples from the unlabeled training dataset, the pseudo-labels having a confidence value that is higher than a threshold value, to be used in a next iteration of the training.

8. The method of claim 7, wherein the iterative training terminates after all of the remainder of examples from the unlabeled training dataset have pseudo-labels having a confidence value that is higher than the threshold value.

9. The method of claim 7, wherein the iterative training terminates after a predetermined number of iterations, with any examples of the remainder of examples from the unlabeled training dataset that do not have pseudo-labels having a confidence value that is higher than the threshold value being omitted from training.

10. The method of claim 1, further comprising:
capturing a new image of a road scene;
identifying a defect of a road in the road scene; and
automatically operating a vehicle to avoid the defect.

11. A system for training a model, comprising:
a hardware processor; and
a memory that stores a computer program which, when executed by the hardware processor, causes the hardware processor to:
annotate a subset of an unlabeled training dataset, that includes images of road scenes, with labels; and
iteratively train a road defect detection model, including adding pseudo-labels to a remainder of examples from the unlabeled training dataset and training the road defect detection model based on the labels and the pseudo-labels.

12. The system of claim 11, wherein the training dataset includes images that depict multiple categories of road defect, including cracks, ruts, and faded road markings.

13. The system of claim 11, wherein the training dataset further includes images that depict foliage.

14. The system of claim 13, wherein the computer program further causes the hardware processor to train a foliage detection model that identifies locations where foliage poses a potential future road hazard.

15. The system of claim 14, wherein the foliage detection model identifies pixels that correspond to foliage and pixels that correspond to a road in an input image and determines locations where the foliage extends over the road.

16. The system of claim 15, wherein the foliage detection model combines semantic segmentation of the input image with a depth map based on the input image to identify overlapping foliage points and road points.

17. The system of claim 11, wherein the computer program further causes the hardware processor to add the pseudo-labels to examples from the unlabeled training dataset, the pseudo-labels having a confidence value that is higher than a threshold value, to be used in a next iteration of the training.

18. The system of claim 17, wherein the iterative training terminates after all of the remainder of examples from the unlabeled training dataset have pseudo-labels having a confidence value that is higher than the threshold value.

19. The system of claim 17, wherein the iterative training terminates after a predetermined number of iterations, with any examples of the remainder of examples from the unlabeled training dataset that do not have pseudo-labels having a confidence value that is higher than the threshold value being omitted from training.

20. The system of claim 11, wherein the computer program further causes the hardware processor to:
capture a new image of a road scene;
identify a defect of a road in the road scene; and
automatically operate a vehicle to avoid the defect.
